(19) United States
(12) Patent Application Publication
(10) Pub. No.: US 2011/0189787 A1
(43) Pub. Date: Aug. 4, 2011

(54) SPECTROMETER AND METHOD OF OPERATING A SPECTROMETER

(76) Inventor: Pierre R. Graves, Cardiff (GB)

(21) Appl. No.: 13/054,064

(22) PCT Filed: Jul. 15, 2009
(86) PCT No.: PCT/GB2009/001782

§ 371 Date: Mar. 21, 2011

(30) Foreign Application Priority Data
Jul. 15, 2008 (GB) 0812926.4

(51) Int. Cl. G01N 21/64; H01J 40/14

(52) U.S. Cl. 436/172; 250/458.1; 250/459.1; 250/216

(57) ABSTRACT

A photoluminescence spectrometer (100) is provided comprising; (i) a source of electromagnetic radiation (2) for exciting photoluminescence in a sample (16); (ii) a site (1) for location of the sample (iii) a detector (8) for detecting photoluminescence emitted from the sample and (iv) located in the optical path between the site for location of a sample and the detector, a means (10) of varying the intensity received by the detector of electromagnetic radiation having the same wavelength as the excitation radiation. The mean of varying the intensity may be formed by a tiltable interference filter or by a plurality of movable attenuating filters. A method of using such a spectrometer is also provided.

The present invention relates to a spectrometer for the detection of photoluminescence (such as fluorescence and phosphorescence) and a method of detecting photoluminescence.

In a conventional photoluminescence spectrometer, a sample is illuminated with radiation which causes photoluminescence in samples containing photoluminescence species. This photoluminescence is sensed by a detector. It is undesirable to detect the excitation radiation and so it is removed from the optical path by one or more filters.

However, in a conventional spectrometer it is difficult to determine whether a sample contains any species which absorb radiation, in particular the excitation radiation. Such absorbing species can interfere with photoluminescence measurements.

The present invention provides a solution to the above-mentioned problem.

In accordance with a first aspect of the present invention, there is provided a photoluminescence spectrometer comprising;

(i) a source of electromagnetic radiation for exciting photoluminescence in a sample;
(ii) a site for location of the sample
(iii) a detector for detecting photoluminescence emitted from the sample
(iv) located in the optical path between the site for location of a sample and the detector, a means of varying the intensity received by the detector of electromagnetic radiation having the same wavelength as the excitation radiation

The spectrometer of the present invention permits the user to determine whether a sample contains species which absorb excitation radiation. The spectrometer may optionally permit the user to examine Raman scattered radiation from the sample, which may be absorbed at longer wavelengths than the excitation radiation.

Those skilled in the art will realise that the sample is not part of the spectrometer of the present invention.

The term “photoluminescence” includes fluorescence and phosphorescence, and hence the term “photoluminescence radiation” includes fluorescent and phosphorescent radiation.

The excitation radiation is that radiation which is incident on a sample for exciting photoluminescence. The source of electromagnetic radiation may emit a relatively broad spectrum of radiation, including excitation radiation, in which case it is usual to remove the extraneous radiation (i.e. that radiation which is not excitation radiation) With a filter (typically a band pass filter).

The means of varying the intensity may, in use, vary the intensity received by the detector of electromagnetic radiation having the same wavelength as the excitation radiation more than it varies the intensity of photoluminescence radiation received by the detector.

For example, the means of varying the intensity may comprise a long pass filter or a band pass filter (typically a broad band pass filter). Tilting of the long pass or band pass filter from one position may give rise to a substantial increase (many hundreds of percent) in the intensity of radiation having the same wavelength as the excitation radiation received by the detector, whereas tilting of the long pass filter may lead to a small decrease (a few percent e.g. below 10%) in the intensity of photoluminescence radiation received by the detector.

It is preferred that the means of varying the intensity comprises a means of varying the intensity received by the detector of electromagnetic radiation having the same wavelength as the excitation radiation without substantially varying the intensity of photoluminescence radiation received by the detector.

The means of varying the intensity may comprise one or more long pass or band pass filters. The one or more long or band pass filters may be interference filters. The means for varying the intensity may comprise a single (i.e. only one) long pass or band pass filter. This long pass or band pass filter may be tiltable so as to vary the wavelengths of radiation permitted to pass through the filter. Tilting a long pass or band pass interference filter from a normal position (i.e. one in which the filter is normal to the direction of incident radiation) causes the “edge” at which radiation is permitted to pass through the filter to move to a shorter wavelength (the greater the deviation from the normal position, the shorter the wavelength of the “edge”). The long pass or band pass filter may be tiltably mounted, preferably in a housing. The housing may comprise a portion of conduit. The portion of conduit may be made from light-impermeable material. The portion of conduit may form part of a light-impermeable conduit in the spectrometer. The portion of conduit may be matable with other portions of the light-impermeable conduit. The portion of conduit may be provided with one of more mating configurations (preferably two, one at each end of the conduit).

The tiltable long pass or band pass filter is particularly preferred because it is simple to produce and simple to operate automatically. Furthermore, since the angle of tilt may be altered by small amounts, it is possible to easily “tune” the filter.

It is preferred that the filter is tiltable through an angle of up to 30 degrees with respect to the incident light.

The means of varying the intensity may comprise a plurality of interference filters (such as long pass or band pass filters), the cut-off wavelength of each of the filters being mutually different from one another. Alternatively, the means of varying the intensity may comprise a plurality of attenuating filters, the degree of attenuation of each of the filters being mutually different from one another. The filters should attenuate exciting radiation and not photoluminescence radiation. At any one time, one of the filters would be in the optical path between the sample site and the detector. The filters may be movable to selectively position one of the plurality of filters in the optical path between the sample site and the detector. The plurality of filters may be mounted on a movable carrier. The carrier may be arranged for rotational motion or translational motion for moving the filters.

The light source may comprise a laser. The light source may emit radiation over a relatively broad spectrum. In this case, the spectrometer may be provided with a bandpass filter in the optical path between the light source and the sample site. The bandpass filter provides radiation having a relatively narrow wavelength spectrum to the sample.

The detector may be a photodiode (such as an avalanche photodiode) or a photomultiplier tube.

In accordance with a second aspect of the present invention, there is provided a means of varying the intensity received by the detector of electromagnetic radiation having the same wavelength as the excitation radiation, the means of varying the intensity being for use in the spectrometer of the first aspect of the present invention.

In accordance with a third aspect of the present invention, there is provided a component for a photoluminescence spectrometer, the component comprising a tiltable interference filter located in a housing made from light-impermeable material.

“Light-impermeable” means substantially impermeable to visible light (i.e. light having a wavelength of from 450 to 700 nm). It is preferred if the material is impermeable to light having a wavelength of from 200 nm to 2 microns.

The long pass filter may have those properties as described with reference to the spectrometer of the first aspect of the present invention. For example, it is preferred that the filter is tiltable through an angle of up to 30 degrees.

The housing may have those properties as described with reference to the spectrometer of the first aspect of the present invention. For example, the housing may be provided by a portion of conduit. The portion of conduit may, in use, form part of a light-impermeable conduit in the spectrometer. The portion of conduit may be matable with other portions of light-impermeable conduit in a spectrometer. To facilitate this, the portion of conduit may be provided with one of more mating configurations (preferably two, one at each end of the conduit). The one or more of the mating configurations may be matable with corresponding mating configurations provided on other portions of light-impermeable conduit in a spectrometer.

In accordance with a fourth aspect of the present invention, there is provided a method of operating a photoluminescence spectrometer, the method comprising:

(i) providing a photoluminescence spectrometer having a detector;
(ii) providing a sample
(iii) illuminating the sample with excitation radiation
(iv) sensing the characteristics of the radiation from the sample with the detector
(v) subsequent to step (iv), in the optic path between the sample and detector, acting so as to vary the intensity of the electromagnetic radiation of excitation wavelength incident on the detector
(vi) subsequent to step (v), sensing the characteristics of radiation with the detector.

It is preferred that step (v) comprises acting so as to vary the intensity of the electromagnetic radiation of excitation wavelength incident on the detector, whilst varying the intensity of the photoluminescence radiation incident on the detector by a lesser degree.

It is further preferred that step (v) comprises acting so as to vary the intensity of the electromagnetic radiation of excitation wavelength incident on the detector without substantially varying the intensity of the photoluminescence radiation incident on the detector.

One or both of steps (iv) and (vi) may comprise measuring the intensity of radiation as a function of time. This may be performed directly (i.e. measuring the intensity as a function of time in one timeframe) or indirectly (for example, measuring the time a photon takes to reach the detector (such as in time-correlated single photon counting)). One of both of steps (iv) and (vi) may comprise frequency domain analysis.

The method of the present invention may comprise providing a tiltable long pass or band pass filter. In this case, step (iv) may comprise tilting the long pass or band pass filter from a first orientation to a second orientation.

The method of the present invention may further comprise having a pre-determined desirable value for the characteristics of radiation. In this case, the measurement of the characteristic made in step (vi) may be compared with the pre-determined desirable value.

In the event that the initial measurement made in step (vi) does not compare favourably with the pre-determined desirable value (for example, the measured intensity of radiation detected is lower than the pre-determined desirable value by an unacceptably large margin), the method may comprise repetition of steps (v) and (vi) until the predetermined desirable value for the characteristics of radiation is reached. For example, it is sometimes desirable that the pre-determined value of the intensity of electromagnetic radiation having substantially the same wavelength as the excitation radiation is approximately the same as the intensity of the fluorescent radiation.

For example, this may comprise tilting a tiltable filter, measuring the intensity of radiation (preferably as a function of time) and comparing the intensity of radiation with a pre-determined desirable value of the intensity of radiation. The tilting/measurement/comparison process would be repeated until the measured value was equal to the predetermined value. Those skilled in the art will realise that the pre-determined value may comprise a range of values.

The method of the present invention may comprise providing a plurality of samples. In this case, steps (v) and (vi) may only be performed on one sample (the first sample). It is preferred that the measurement of step (vi) is compared with a pre-determined desirable value. In the event that the initial measurement made in step (vi) does not compare favourably with the pre-determined desirable value (for example, the measured intensity of radiation detected is lower or higher than the pre-determined desirable value by an unacceptably large margin), it is preferred that steps (v) and (vi) are repeated for the first sample until a predetermined desirable value for the characteristics of radiation is reached. As indicated above, this may typically involve typically tilting a filter until a pre-determined desirable value for the characteristics of radiation is reached. Once the pre-determined desirable value has been reached using the first sample, measurements may be performed on the other samples. This typically involves moving a sample into position for exposure to the excitation radiation, illuminating the sample and sensing the characteristics of the radiation from the sample. Another sample would then be moved into position for exposure to the excitation radiation, such movement moving the previously-analysed sample out of the position for exposure to radiation.

The method of the fourth aspect of the present invention may be performed using the apparatus of the first aspect of the present invention and/or the component of the third aspect of the present invention.

In accordance with a fifth aspect of the present invention, there is provided a method of determining the presence of a species in a sample and the presence of a secondary influencing species, the method comprising:
(i) providing the sample with reagents for a photoluminescence assay, at least one of said reagents comprising a photoluminescent species;
(ii) measuring the photoluminescence radiation from the sample;
(iii) determining a characteristic of the photoluminescence radiation emitted by the photoluminescent species and detected by the detector by applying a mathematical model to fit the measured photoluminescence; and
(iv) comparing said determined characteristic with a pre-determined value, wherein the relationship between the determined characteristic and the predetermined value is indicative of the presence or absence of said species in the sample and/or indicative of the presence or absence of a secondary influencing species.

It is preferred that the species comprises a photoluminescent species (such as a fluorescent species). It is preferred that the secondary influencing species comprises a species capable of absorbing radiation of the same wavelength as radiation used to illuminate the photoluminescent species.

Step (ii) preferably comprises measuring the intensity of photoluminescence radiation as a function of time. In which case, step (iii) comprises applying a mathematical model to fit the intensity as a function as time. This may typically comprise fitting the data with the model

I(t)=I₀e^{(-t/τ})+b (equation 1)

where I(t) is intensity as a function of time, I₀ is the intensity at t=0, t is the time, i is the photoluminesence lifetime and b is a constant. I₀ may be the determined characteristic of the photoluminesence and directly related to the presence of said photoluminescent species.

If I₀ is lower than the pre-determined value, then this may be indicative of the presence of secondary influencing species in the sample. This is particularly the case if the secondary species is a reaction inhibitor (for example, an inhibitor of an enzyme, such as a proteolytic enzyme which cleaves peptides). Such peptides may be provided in a sample, the peptides being provided with a fluorescent species and optionally a quencher for quenching the fluorescent radiation emitted by the fluorescent species.

Step (iii) may comprise fitting the data with the model:

$$I ( t ) = {\sum }_{1}^{n} {I}_{n} ( t ) ,$$

where there are “n” photoluminescent species and I(t) is the measured photoluminescence intensity as a function of time and Iₙ is the fluorescent intensity generated by the n^{th} fluorescent species, and “n” is typically up to 3, more typically 2 and most typically 1.

Iₙ(t) is typically of the form I₀₍ₙ₎e^{(-t/τ(n))}+c (i.e. the same form as Equation 1) wherein I₀₍ₙ₎ is the intensity of photoluminescence radiation from the n^{th} photoluminescent species at t=0, τ(n) is the photoluminescence lifetime of the n^{th} species and c is a constant.

Such a model caters for there being more than one photoluminescent emitter in the sample. The incorporation of more than one emitter into a model may, however, increase the goodness of the fit, even though there is only one emitter present. Known techniques (such as Bayesian inference) may be used to determine whether it is likely that a second emitter is present.

It is preferred that the reagents for the assay are reagents for a fluorescence assay (such as a fluorescence quenching-based assay). It is therefore preferred that the photolumlinescent species is a fluorescent species.

In accordance with a sixth aspect of the present invention, there is provided a method of determining the presence of a radiation-absorbing species suspected of being present in a sample, the sample comprising a fluorescent species, the method comprising:
(i) illuminating the sample with excitation radiation
(ii) measuring the photoluminescence radiation from said sample and
(iii) measuring the radiation from the sample having a wavelength substantially the same as the excitation radiation
(iv) the values of one or more of the measurement of (ii), the measurements of (iii) and the ratio of (ii) and (iii) being indicative of the presence or otherwise of the radiation-absorbing species.

The radiation absorbing species may absorb and spontaneously re-emit the excitation radiation. In this case, a high value of the measurement of (iii) may be indicative of the presence of a radiation absorbing species. For example, the radiation-absorbing species may be Natural Yellow and the fluorescent species may be acridone.

The method may comprise providing a plurality of samples, each sample being subject to steps (ii) and (iii) above. Measurements of (ii) and (iii) between different samples may be used to indicate the absence or presence of radiation-absorbing species. For example, a sample including a radiation-absorbing species may show a low fluorescent (phosphorescence) signal. This may or may not be due to a low concentration of fluorescent moiety in a sample. The presence of a high value in measurement step (iii) may be indicative of the presence of the absorbing species.

The value of the measurement in step(iii) may be indicative of the amount of radiation-absorbing species in the sample.

The present invention will now be described by way of examples only with reference to the following figures of which:

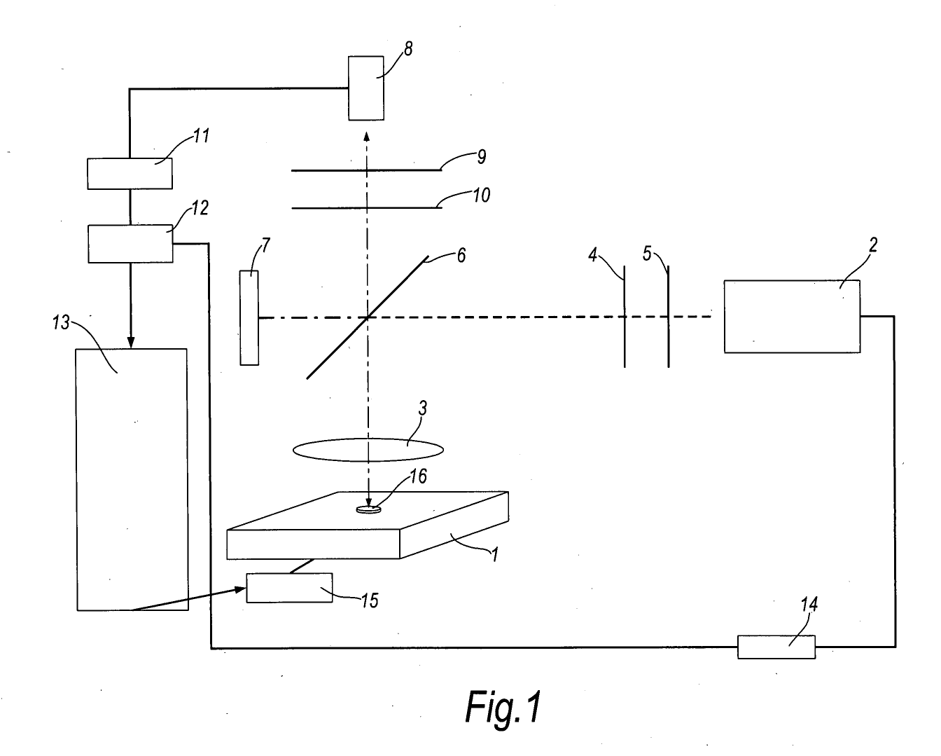

FIG. 1 is a schematic representation of an example of an embodiment of a spectrometer in accordance with the present invention;

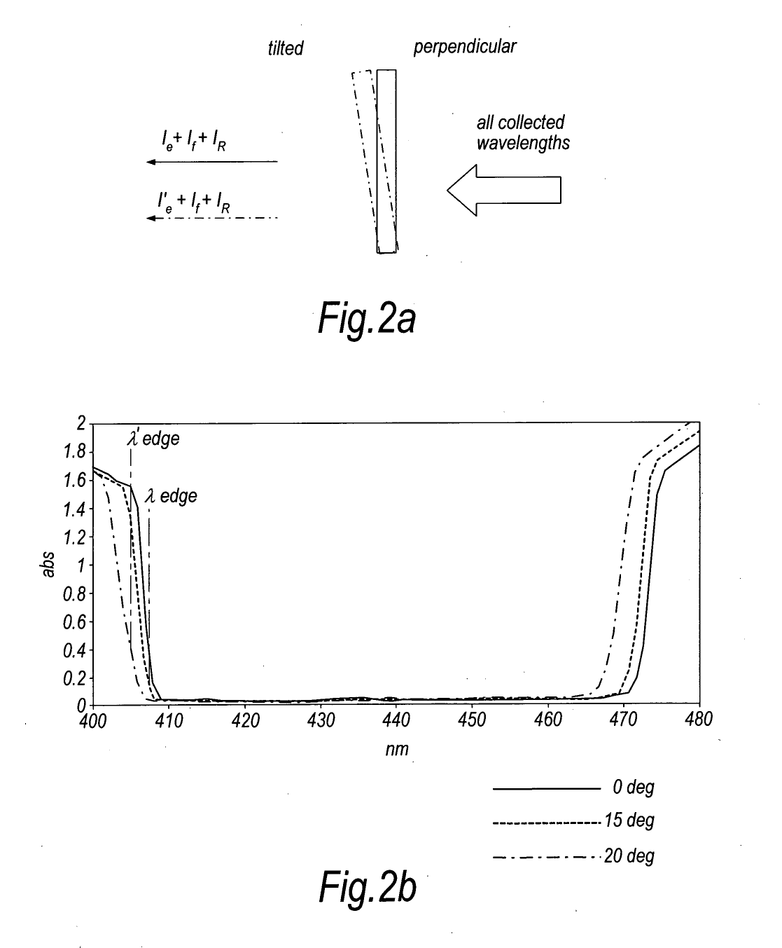

FIG. 2a is a schematic representation of the effect of tilting the interference filter on the intensity of light transmitted through the interference filter;

FIG. 2b shows the bandpass characteristics of a band pass filter as a function of tilt angle;

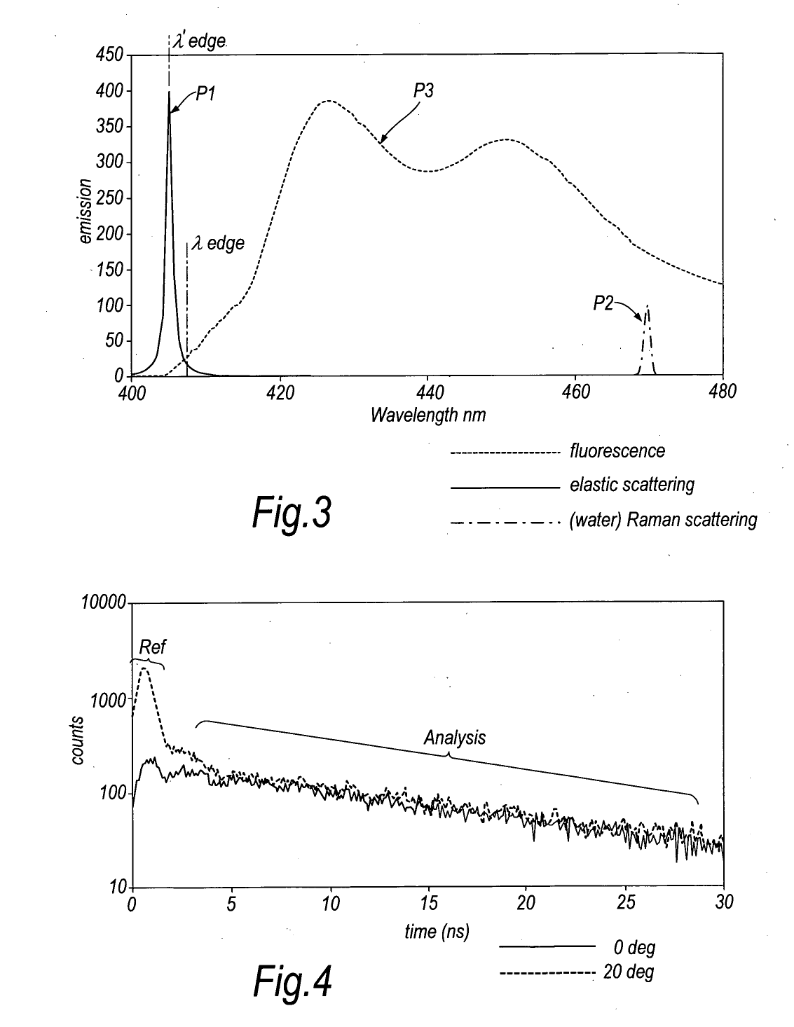

FIG. 3 shows how the emitted detected intensity from a typical sample varies with wavelength for radiation having the same wavelength as the excitation wavelength, fluorescent radiation and Raman scattering;

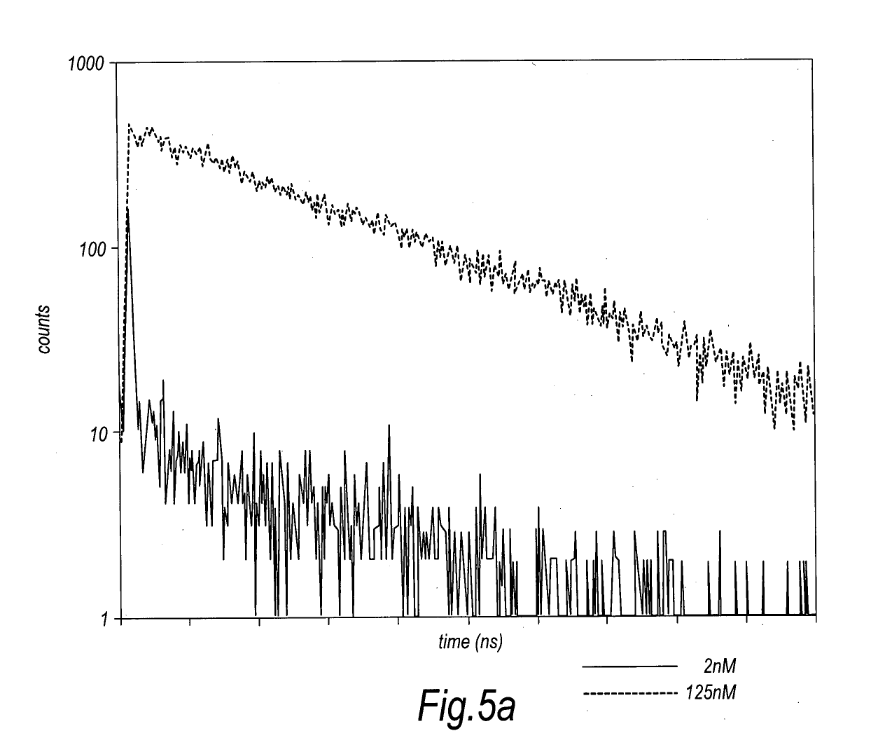

FIG. 4 is a typical representation of how fluorescent intensity varies with time after a sample is excited and how the intensity changes as a function of the tilt angle of the band pass filter;

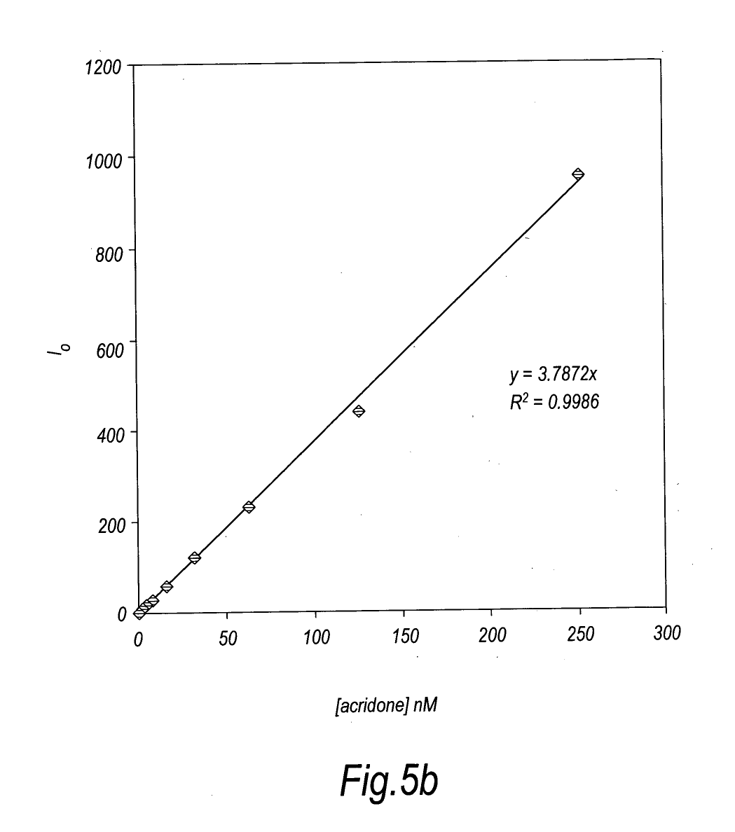

FIG. 5a shows how the intensity detected by the detector varies with time immediately after illumination of the sample, showing the reference light and fluorescent light;

FIG. 5b shows the variation of I₀ (the projected fluorescent intensity at t=0) with concentration of fluorescent species;

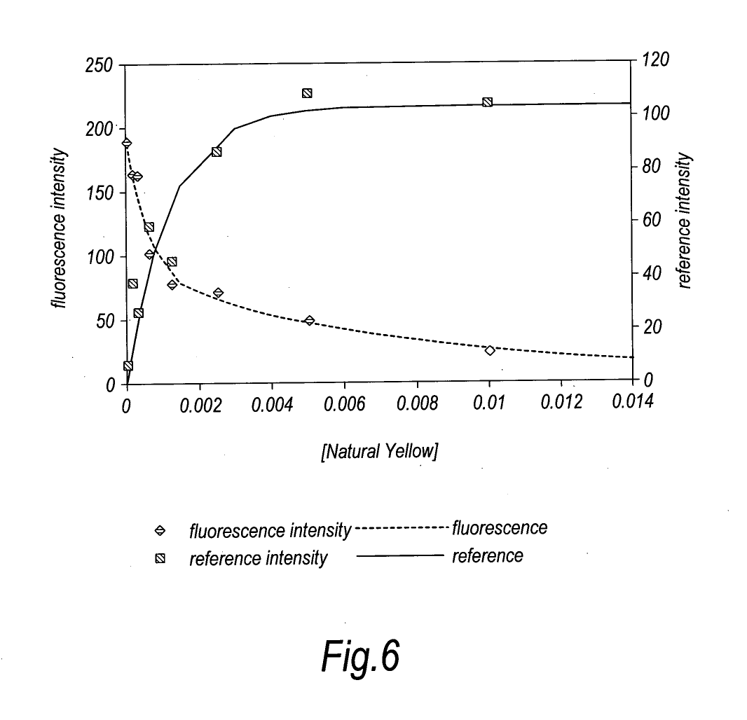

FIG. 6 shows the variation of the fluorescent intensity (I₀) and the detected intensity of radiation having substantially the same wavelength as the excitation radiation as a function of the concentration of an absorbing-species;

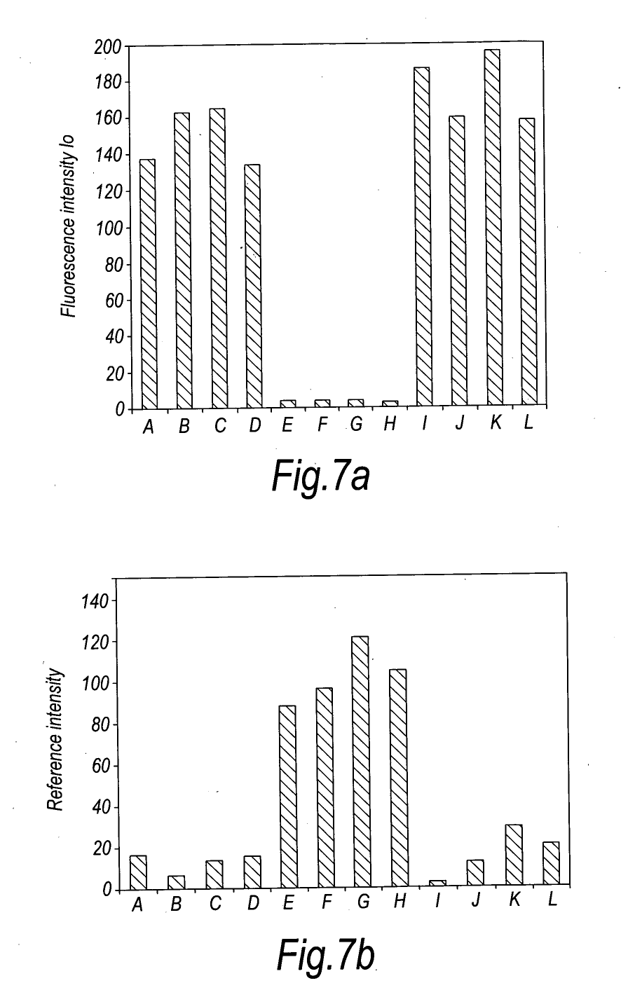

FIGS. 7a and 7b show the projected fluorescent intensity at t=0 (I₀) and the detected intensity of radiation having substantially the same wavelength as the excitation radiation respectively for a series of sample, some of which contain a radiation-absorbing species;

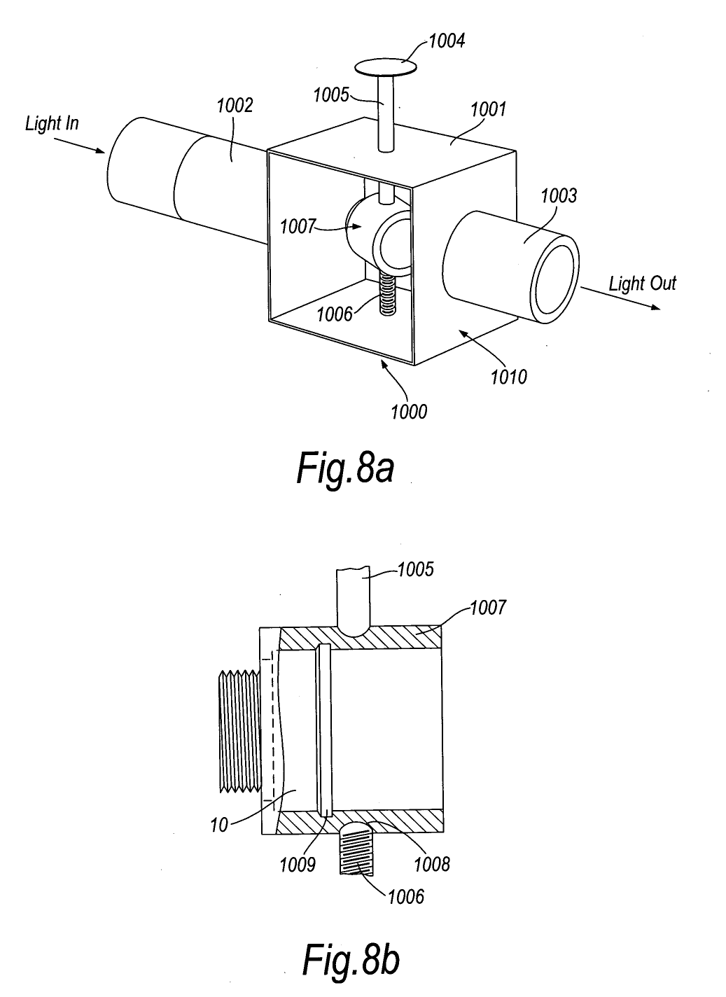

FIG. 8a shows a cutaway view of an example of a component of a spectrometer in accordance with the third aspect of the present invention; and

FIG. 8b shows a cross-sectional view through the component holder used in the component of FIG. 8a.

An example of a spectrometer in accordance with the first aspect of the present invention is shown schematically in FIG. 1. The spectrometer (denoted generally by reference numeral 100) comprises a source of electromagnetic radiation 2 (in this case, a Picoquant LDH-P-C-405) in the form of an LED or a laser. Excitation light is directed onto a sample 16 (typically an aqueous solution) located at a sample site 1 (e.g. a black polypropylene Matrix 384 well microtitre plate). Fluorescent and elastically scattered radiation are then transmitted to a detector 8 (such as a Hamamatsu R7400P photomultiplier) through a tiltable broad bandpass filter 10 (in this example, an Edmund Optics F48-074 447/60 nm bandpass filter). Tilting of the broad bandpass filter 10 varies the “cut-off” edge wavelength at which the amount of radiation transmitted through the filter is substantially reduced. For example, tilting the filter from a perpendicular orientation causes the cut-off wavelength to move a shorter wavelength (as shown in FIG. 2b).

A neutral density filter 4 is provided in the optical path between the light source 2 and the sample 16 in order to reduce the intensity of radiation incident on the sample 16.

Those skilled in the art will realise that the neutral density filter 4 may not be needed, dependent on the intensity of the radiation emitted by the source of radiation 2 and other experimental parameters.

An emission bandpass filter 5 (for example, an Edmund Optics F43-052 405 nm laser line filter) is provided in the optical path between the source of radiation 2 and the sample 16 in order to provide radiation of the desired wavelength to the sample 16. For example, some sources of radiation may emit a broad spectrum of radiation, which is generally undesirable. Light which has passed through the emission bandpass filter 5 and neutral density filter 4 is incident on a beamsplitter 6 (e.g. Edmund Optics F54-824 beamsplitter assembly) tilted at 45 degrees. Half of the radiation incident on the beamsplitter 6 passes through the filter into a beam dump 7. The remainder of the radiation incident on the beamsplitter 6 is directed via a lens 3 (e.g. an Edmund Optics F48-041 20 mm DCX lens) onto the sample 16. The lens 3 focusses radiation onto the sample 16 and also serves to collect radiation from the sample 16. Radiation from the sample is also collected by lens 3 and passes through beamsplitter 6. The radiation then impinges on the broad bandpass filter 10. Radiation which passes through the broad bandpass filter 10 is then incident on a detection bandpass filter 9. The detection bandpass filter 9 is selected to further restrict passage therethrough of the photoluminescent radiation, blocking Raman shifted radiation and further attenuating radiation having the same wavelength as the excitation radiation (if radiation of this wavelength has been permitted to pass by the broad bandpass filter 10).

Radiation is detected by the detector 8 (in this case, a photomultiplier tube).

The way in which data are recorded depends on the timescale of the photoluminescence. If the photoluminescence occurs over relatively long periods (greater than 1 ms, for example), then data may be transmitted from the detector, via a pre-amplifier 11 (in this case, an Ortec 9327) to a timing card with a fast-sampling analogue-to-digital convertor 12 (e.g. an Ortec 9353). This allows the current to be measured directly as a function of time following an excitation pulse.

If the photoluminescence occurs over a shorter timescale (as is often the case), then it may be desirable to use a gated detection technique. The output of the detector is measured for fixed, short durations of time for a given delay between the pulse and the measurement period. The delay between the pulse and the measurement period may then be varied in order to measure the time dependence of the fluorescence.

Alternatively, a time-correlated single photon counting (TCSPC) method may be used to measure the time-dependence of the photoluminescence emission because it permits the measurement of photoluminescence decays over a very wide timescale (sub-nanoseconds to seconds). The signal detected by the detector is transmitted to the TCSPC card via pre-amplifier 11. The TCSPC function is provided by histogramming memory in the timing card 12) mounted in a personal computer 13 and is used to collect data using the TCSPC technique. TCSPC operation of the timing card 12 is synchronised with pulses of radiation emitted by the source of radiation 2 by means of a reference signal from the power supply unit 14 (e.g. a Picoquant PDL 800-B) of the source of radiation. Such TCSPC cards or modules are available from Becker & Hickl GmbH, Berlin, Germany (for example, the SPC series, including the SPC-130 and SPC-134) and PicoQuant GmbH, Berlin, Germany (for example, the PicoHarp 300 or HydraHarp 400).

In the present example, sample 16 is one of an array of samples located on an x-y translation stage 1. The x-y translation stage may be operated to move different samples into the position in which samples may be measured. In this way, data on many samples may be acquired over a relatively short period of time and with minimal input from a human operator.

The operation of the apparatus 100 will now be described in greater detail. The sample comprises an aqueous solution of acridone dye. The excitation radiation has a wavelength of 405 nm. FIG. 3 shows the intensity of radiation detected from the sample as a function of wavelength. There are three distinct components; component P1 is a sharp peak centred around 405 nm and corresponds to radiation having the same wavelength as the excitation radiation. This is radiation which has been elastically scattered by the sample. Component P2 is a Raman peak from the water in the sample and component P3 is the fluorescence radiation emitted from the dye in the sample. In a conventional spectrometer a long pass filter is arranged to inhibit radiation having a wavelength of less than λ_{edge} from reaching the detector; this is because it is conventionally only desired to measure the fluorescent radiation, not the spontaneously scattered radiation. Detector band pass filter 9 is arranged so as to preferentially transmit radiation having a wavelength between about 440 and 460 nm (corresponding to a wavelength which gives a maximum intensity of component P3).

In the spectrometer of the present invention, if the band pass filter is tilted as shown in FIG. 2a, then the band pass filter inhibits radiation having a wavelength of less than λ′_{edge} from reaching the detector, where λ′_{edge} is less than λ_{edge}. Referring to FIG. 3, this means that a greater intensity of radiation from component P1 will reach the detector (I′ₑ, the intensity of elastically scattered radiation when the band pass filter 10 is tilted is greater than Iₑ, the intensity of the elastically scattered radiation when the band pass filter is normal to the incident radiation). The tilting of the band pass filter does not have a substantial effect on the intensity of fluorescent radiation (I_{F}) and only reduces the intensity of Raman radiation (I_{R}) reaching the detector when tilted more than 15 degrees (compare the absorbance characteristics of the filter in FIG. 2b with the position of the Raman peak in FIG. 3).

As described above, by tilting the broad bandpass filter 10, the intensity of the signal recorded in the “Ref” region may be altered, the greater the angle of tilt from the normal position, the greater the intensity of radiation transmitted in the “Ref” region. The operating position is generally one in which the filter is normal to the incident radiation. The intensity of radiation in the “Ref” region is indicative of whether any absorbing species are present in the sample which is being analysed; if an absorbing species is present, the intensity of radiation in the “Ref” region will be greater for a given angular displacement of the band pass filter from the normal position than if no absorbing species was present.

Therefore, in an example of one method of the present invention, measurements of the intensity of the “Ref” region may be made as a function of the angular displacement of the band pass filter from the normal position. In this case, the intensity in the “Ref” region would increase as the angular displacement is increased, while the intensity in the “Anal” region would remain substantially the same as the angular displacement is increased.

This effect may be used to analyse a plurality of samples. Measurements are performed as mentioned above on a first sample in order to identify the optimum angular displacement of the filter from the normal position. Once the optimum angular position of the filter has been identified, measurements are performed on the other samples, keeping the filter in the optimum angular position.

### EXAMPLE 1

FIGS. 4 and 5a show how the detected light intensity varies with time post-illumination of the sample. FIG. 4 shows the measured intensity as a function of time with the band pass filter 10 tilted at 0° (solid line) and 20° (dashed line). FIG. 4 shows an exponential decrease in intensity from several nanoseconds to about 30 nanoseconds post-illumination; this decay in intensity is the fluorescence signal and is unaffected by tilting the filter. At short time (0-2 nanoseconds), the spontaneously scattered radiation is observed. The intensity of this component increases significantly as the filter is tilted.

FIG. 5a shows how the detected light intensity varies as a function of acridone dye concentration using samples comprising 125 nM acridone (dotted line) and 2 nM acridone (solid line).

The region in FIG. 4 marked “Ref” corresponds to radiation having the same wavelength as excitation radiation (i.e. elastically scattered radiation) and Raman radiation. It is worth noting that the signal in the “Ref” region is not a single delta function due to there being two types of radiation being detected in this region (Raman and elastically scattered radiation). Further reasons for there not being a single delta function are the response times of the detector and associated electronics, the temporal width of the excitation pulse and the temporal resolution of the intensity measurement.

The region in FIG. 4 marked “Analysis” corresponds to fluorescent radiation. A simple non-linear regression analysis of this region according to (equation 1) yields I₀ for each concentration of acridone. FIG. 5b shows that there is a quantitative linear relationship between parameter I₀ and dye concentration (see FIG. 5b). The mathematical method described originally by Marquardt (Marquardt, D. W. 1963, Journal of the Society of Industrial and Applied Mathematics, vol. 11 pp 431-441) was used.

### EXAMPLE 2

The relative intensity of the elastically scattered “Ref” region may give a qualitative or quantitative determination of the presence of absorbing species.

FIG. 6 shows the increasing intensity of the “Ref” region and the decreasing fluorescence intensity values (I₀) obtained from aqueous samples containing the absorber Natural Yellow (a proprietary mixture of curcumin and annatto) and acridone. All samples contained acridone (50 nM) and various concentrations of Natural Yellow. The results may be explained as follows.

With no Natural Yellow the detected intensity in the “Ref” region is very low. Natural Yellow absorbs the excitation light and so the measured fluorescent intensity decreases as the concentration of Natural Yellow increases because the Natural Yellow absorbs light which would otherwise excite fluorescence in the acridone. Natural Yellow also scatters the excitation light and does so isotropically. Some of this isotropically scattered light of the same wavelength as the excitation radiation is scattered towards the detector. As the concentration of Natural Yellow increases, the intensity of the isotropically scattered light increases, at least over a small range of concentrations. Hence, a high intensity reference signal and a low fluorescence signal may be indicative of the presence of an absorbing species.

FIG. 7a shows how the fluorescence intensity derived from the “Analysis” region varied in 12 samples A to L. FIG. 7b shows how the intensity derived from the “Ref” region varied in 12 samples A to L. All samples contained approximately 50 nM acridone dye and samples E to H also contained Natural Yellow. Based on the fluorescence intensities and without prior knowledge, it is impossible to say whether samples E to H contain less acridone than the other samples or whether they also contain an absorber. The higher intensities of the “Ref” region confirm that an absorber is present in samples E to H.

The apparatus and method of the present invention may be used with fluorescent assays, the fluorescence signal being measured being that generated by a component of the assay (or product thereof). In such assays, the intensity of the fluorescent signal is indicative of the progress of a reaction. In turn, the progress of the reaction may be indicative of the presence of any reaction-inhibitors. Analysis of the “Analysis” region also facilitates the determination of whether the subject under investigation (such as a potentially beneficial pharmaceutical compound) contains any fluorescent species which may interfere with measurements. Each fluorescent species has a typical decay time; if two fluorescent species are present (for example, one from the subject of the investigation and one from the assay), then the data from the “Analysis” region can be analysed to separate the two different fluorescence processes and calculate the two decay times.

The method of the present invention may be used, for example, in a fluorescence intensity assay to determine the presence (and optionally the concentration) of an enzyme inhibitor. The sample may comprise a peptide which is labelled with both a fluorophore and a quencher; when the fluorophore and quencher are in proximity to each other, the quencher quenches the radiation emitted by the fluorophore. The sample further comprises a proteolytic enzyme for cutting the peptide at a point between the fluorophore and the quencher. When the peptide is cut, the distance between the fluorophore and quencher increases, and the effectiveness of the quencher decreases (with the result that radiation emitted by the fluorophore is detected). If the sample comprises an enzyme inhibitor, the activity of the enzyme is reduced and so the intensity of fluorescent radiation detected is reduced.

FIGS. 8a and 8b show an example of an embodiment of a component for a spectrometer in accordance with the third aspect of the present invention. The component is generally denoted by reference numeral 1000 and comprises the broad band pass filter 10 tiltably mounted in a housing 1001. FIG. 8a is shown with one part of the housing 1001 removed so that the arrangement of the component 1000 can be more clearly seen. The filter 10 is located in a component holder 1007, held in place by a retaining ring 1009. The component holder 1007 is connected to an axle 1005, the handle being provided with a handle 1004. The seat 1008 of the holder 1007 sits atop the end of a ball-tipped screw 1006 so that rotation of the handle 1004 and axle 1005 causes rotation of the holder 1007 and therefore tilting of the filter 10, thus enabling the user to change the angle of the filter 10 to the incident radiation.

The holder 1007 is mounted in a holder-containing box portion 1010 of the housing 1001. The housing further comprises conduits 1002, 1003 which are suitable for connection to other components of a spectrometer (e.g. other conduits of the spectrometer). The housing 1001 is made from light-impermeable material (typically anodised aluminium alloy).

In use, light passes through the component as shown in FIG. 8a.

1. A photoluminescence spectrometer comprising;
(i) a source of electromagnetic radiation for exciting photoluminescence in a sample;
(ii) a site for location of the sample
(iii) a detector for detecting photoluminescence emitted from the sample
(iv) located in the optical path between the site for location of a sample and the detector, a means of varying the intensity received by the detector of electromagnetic radiation having the same wavelength as the excitation radiation.

2. A spectrometer according to claim 1 wherein the means of varying the intensity, in use, varies the intensity received by the detector of electromagnetic radiation having the same wavelength as the excitation radiation more than it varies the intensity of photoluminescence radiation received by the detector.

3-5. (canceled)

6. A spectrometer according to claim 1 wherein the means for varying the intensity comprises a long pass or band pass filter which is tiltable so as to vary the wavelengths of radiation permitted to pass through the filter.

7. A spectrometer according to claim 6 wherein the long pass or band pass filter is tiltably mounted in a housing, the housing comprising a portion of conduit made form light-impermeable material, the portion of conduit forming part of a light-impermeable conduit in the spectrometer.

8-9. (canceled)

10. A spectrometer according to claim 7 wherein the filter is tiltable through an angle of up to 30 degrees.

11-15. (canceled)

16. A component for a photoluminescence spectrometer, the component comprising a tiltable interference filter located in a housing made from light-impermeable material.

17. A component according to claim 16 wherein the interference filter is a long pass filter or a broad bandpass filter.

18. A component according to claim 16, wherein the housing s comprises a portion of conduit made from light-impermeable material, the portion of conduit, in use, forming part of a light-impermeable conduit in the spectrometer.

19. (canceled)

20. A method of operating a photoluminescence spectrometer, the method comprising:
(i) providing a photoluminescence spectrometer having a detector;
(ii) providing a sample
(iii) illuminating the sample with excitation radiation
(iv) sensing the characteristics of the radiation from the sample with the detector
(v) subsequent to step (iv), in the optic path between the sample and detector, acting so as to vary the intensity of the electromagnetic radiation of excitation wavelength incident on the detector
(vi) subsequent to step (v), sensing the characteristics of radiation with the detector.

21. A method according to claim 20 wherein step (v) comprises acting so as to vary the intensity of the electromagnetic radiation of excitation wavelength incident on the detector, whilst varying the intensity of the photoluminescence radiation incident on the detector by a lesser degree.

22. (canceled)

23. A method according to claim 20 wherein one or both of steps (iv) and (vi) comprise measuring the intensity of radiation as a function of time.

24. A method according to claim 20 wherein step (v) comprises tilting a long pass or band pass filter from a first orientation to a second orientation.

25. A method according to claim 20, the method further comprising having a pre-determined desirable value for the characteristics of radiation and comparing the measurement made in (vi) with the predetermined desirable value and repeating steps (v) and (vi) until the pre-determined desirable value for the characteristics of radiation is reached.

26. (canceled)

27. A method according to claim 20 comprising providing a plurality of samples, wherein steps (v) and (vi) are only performed on one sample (the first sample).

28. A method of determining the presence of a species in a sample and the presence of a secondary influencing species, the method comprising:
(i) providing the sample with reagents for a photoluminescence assay, at least one of said reagents comprising a photoluminescent species;
(ii) measuring the photoluminescence radiation from the sample;
(iii) determining a characteristic of the photoluminescence radiation emitted by the photoluminescent species and detected the detector by applying a mathematical method to fit the measured photoluminescence to a pre-determined model; and (iv) comparing said determined characteristic with a pre-determined value, wherein the relationship between the determined characteristic and the predetermined value is indicative of the presence or absence of said species and/or indicative of the presence or absence of a secondary influencing species in the sample.

29. A method of claim 28 wherein step (ii) comprises measuring the intensity of photoluminescence radiation as a function of time and step (iii) comprises applying a mathematical method to fit the intensity as a function as time.

30. A method of determining the presence of a radiation-absorbing species suspected of being present in a sample, the sample comprising a fluorescent species, the method comprising:
(i) illuminating the sample with excitation radiation
(ii) measuring the photoluminescence radiation from said sample and
(iii) measuring the radiation from the sample having a wavelength substantially the same as the excitation radiation (iv) the values of one or more of the measurement of (ii), the measurements of (iii) and the ratio of (ii) and (iii) being indicative of the presence or otherwise of the radiation-absorbing species.

31. A method according to claim 30 wherein the radiation absorbing species absorbs the Raman scattered radiation.

32. A method according to claim 30 comprising providing a plurality of samples, each sample being subject to steps (ii) and (iii) above.

33. A method according to claim 29 comprising fitting the data with the model I=I₀e^{(-t/τ)}+b, where I is intensity as a function of time, I₀ is the intensity at t=0, t is the time, τ is the photoluminescence lifetime and b is a constant, wherein I₀ is the determined characteristic of the photoluminescence radiation, further wherein if I₀ is lower than the pre-determined value, then this is indicative of the presence of said species in the sample.
